(19) United States
(12) Patent Application Publication
(10) Pub. No.: US 2008/0227419 A1
(43) Pub. Date: Sep. 18, 2008

(54) Retractable Cell Phone Clip

(76) Inventor: Karen Powell Traub, (US)

Correspondence Address: KAREN POWELL TRAUB, 2907 Andover Glen Road, RALEIGH, NC, 27604-1440, US

(21) Appl. No.: 11/685,535

(22) Filed: Mar. 13, 2007

(51) Int. Cl. H04B 1/18

(52) U.S. Cl. 455/186.1

(57) ABSTRACT

A Retractable Cell Phone Clip wherein a retractable metal cord is pulled out of a case by a bob with a key ring connector securing unit attached to a universal cell phone string securing unit with a cell phone whereby a cell phone remains attached to the metal cord and to whatever it is clipped to (such as clothing, purse, backpack, etc.) while in use and retract when not in use, which makes a cell phone easy to find and hard to loose.

### BACKGROUND

1. Technical Field

This invention relates to a Retractable Cell Phone Clip.

2. Background Art

A retractable cell phone clip is a device having a case inside of which is a reel with a metal cord wrapped around it. The reel is configured such that the free end of the cord can be pulled, thereby rotating the reel, and when the end of the cord is released, the reel automatically rewinds the metal cord. The case typically has a clip/hook attached to the topside for securing it to a shirt, pocket, pants waistband, purse, backpack, etc. of a wearer. The free end of the cord is attached to a key ring connector securing unit which in turn is attached to a universal cell phone securing string.

The purpose of the retractable cell phone clip is to allow a wearer to attach a cell phone to the universal cell phone securing string and to clip the retractable cell phone clip to his or her clothing, purse, backpack, etc., whereby making a cell phone easy to find, extend, and use and also hard to loose because it retracts and stays attached.

### SUMMARY

The Retractable Cell Phone Clip includes a case that houses a reel with a metal cord, which in normal mode is fully retracted within the case with the exception of a free end that extends outside the case through a hole in its periphery. This metal cord is attached at its free end to a key ring connector securing unit that holds the universal cell phone securing string that secures the cell phone. The metal cord can be manually extended from the case reel by a user so that a cell phone can be presented for use. The metal cord is under tension from within the case reel such that when extended and released, or when the free end of the cord reel is guided back toward the case by a user, the tension on the metal cord causes it to retract back into the case and a cell phone back into the retracted position.

The retractable cell phone clip includes a bob that is connected to the free end of the metal cord which is connected to a key ring connector securing unit which has the universal cell phone securing string for attaching a cell phone. The bob is larger than the hole in the periphery of the case through which the cord extends so as to prevent the free end of the cord from retracting completely into the case. In addition, the universal cell phone securing string is connected to the key ring connector which is connected to the bob. Further, the retractable cell phone clip includes a releasable attachment clip/hook that is connected to the topside of the case reel. This clip/hook is capable of releasably attaching the case reel to clothing, a purse or backpack, etc. of a user. In this way, the retractable cell phone clip with cell phone attached to clothing, a purse or backpack, etc. of a user would hang down from the key ring connector attached to the case reel that houses the retractable metal cord which is attached to the clip/hook. It is noted that the tension from the cell phone that is applied to the metal cord in its fully retracted mode is sufficient to hold the bob against the periphery of the case. This ensures that the weight of the cell phone alone does not cause the metal cord to extend. It is also noted that the length of the metal cord is made such that a user can extend the metal cord a sufficient distance to present the cell phone without pulling the cell phone off of its attachment clip/hook to clothing, a purse or backpack, etc.

### DESCRIPTION OF THE DRAWINGS

The specific features, aspects, and advantages of the Retractable Cell Phone Clip will become better understood with regard to the following description, appended claims, and accompanying drawings where:

FIG. 1A is a front view of a retractable cell phone clip and its dimensions, including the topside clip/trigger hook attached to the case reel housing the metal cord attached to the bob attached to the key ring connector with the universal cell phone string attaching a cell phone.

FIG. 1B is a front view of the universal cell phone securing string with dimensions.

FIG. 1C is a front view of the retractable cell phone clip/trigger hook and its dimensions with the metal cord extended to its full 22″ length.

FIG. 2A is a front view of the retractable cell phone clip/hook attached to the belt loop of clothing.

FIG. 3A is a front view of a picture of the actual retractable cell phone clip with cell phone.

FIG. 4A is a front view of the retractable cell phone clip/hook attached to a purse.

FIG. 4B is a front view of the retractable cell phone clip/hook attached to a purse with the metal cord extended with an open cell phone.

FIG. 5A is a front view of the retractable cell phone clip/hook attached to a pants belt loop.

FIG. 5B is a front view of the retractable cell phone clip/hook attached to a pants belt loop with the metal cord extended to the ear of a user of a cell phone.

FIG. 6A is a front view of the retractable cell phone clip/hook attached to a backpack.

FIG. 7A is a inside view of the retractable cell phone clip case and embodiments.

### DETAILED DESCRIPTION OF THE PREFERRED EMBODIMENTS

In the following description of the preferred embodiments of the Retractable Cell Phone Clip which is shown by way of illustration specific embodiments in which this invention may be practiced. It is understood that other embodiments may be utilized and structured changes may be made without departing from the scope of the present invention.

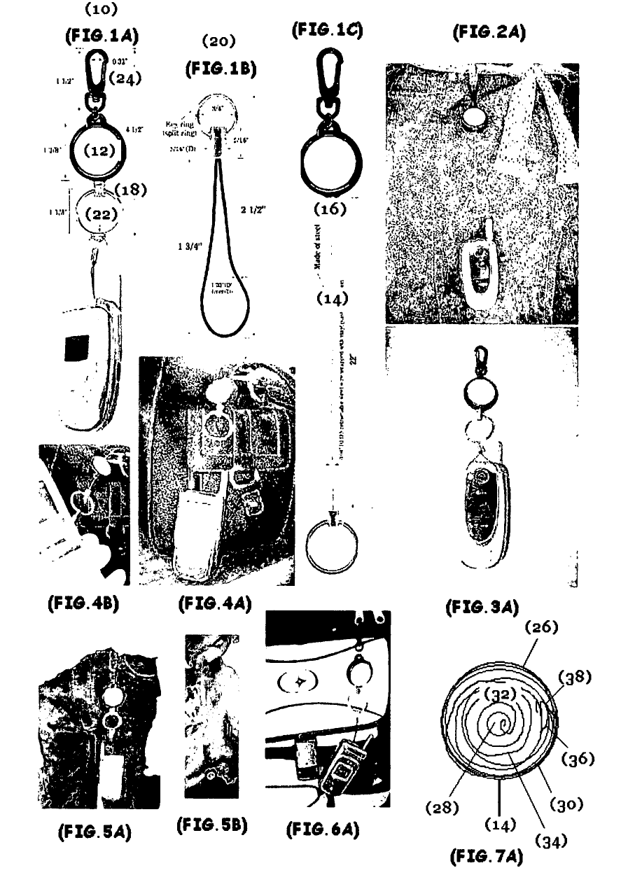

FIGS. 1A, 1B, and 1C depict a retractable cell phone clip/trigger hook (10) embodying the invention. Generally, the retractable cell phone clip (10) is a device having a case (12) inside of which is a reel with an extendable and retractable metal cord (14). The case (12) is shown in FIG. 1A as having a circular shape. However, the case (12) can have any shape desired, such as an ellipical shape (e.g., oval) or polygonal shape (e.g., triangular, square, rectangular, hexagonal, etc.), as desired. The metal cord (14) passes from the interior of the case (12) to the exterior through a port (16) located along the peripheral edge of the case. The end of the cord (14) extending through to the exterior side of the case (12) is attached to a bob (18), which is physically larger than the port (16). As will be explained later in this description, the metal cord (14) is under tension from within the case (12) such that it tends to want to retract into the case (12). In a fully retracted mode, the bob (18) is pulled by the tentioned cord (14) against the exterior of the case (12). This prevents the cord (14) from retracting completely into the case (12). The bob (18) is connected to a universal cell phone string (20) via any appropriate connector, such as the connecting key ring (22) shown in FIGS. 1A and 1C. A connector ring, such as those mentioned previously, is attached to the bob (18) on the case (12) when the retractable cell phone clip (10) is in use. The retractable cell phone clip (10) can be clipped to the wearer via any appropriate releasable device, such as the metal trigger hook (24) shown attached to the topside of the case (12) in FIGS. 1A and 1C. The cell phone can be attached via any appropriate holding device, such as the universal cell phone securing string shown in FIG. 1B.

The retractable cell phone clip (10) normal mode is the aforementioned retracted mode.

In the retracted mode, the cell phone hangs down from the retractable cell phone clip/hook (10), which is typically hooked to clothing, a purse or backpack, etc. of a person wearing the clip (24). When the cell phone is in use, the wearer pulls on the cell phone or connector key ring (22) away from the case (12). The portion of the metal cord (14) contained within the case (12) is extended out as the wearer pulls. It is noted that the length of the metal cord (14) is made long enough so that the cell phone can be readily presented by a user without the metal cord (14) being fully extended from the case. For example, in tested embodiments, the metal cord (14) was made approximately 22″ long. When the wearer releases the cell phone, or guides it back toward the retractable cell phone clip (10), the tension placed on the metal cord (14) pulls the cord back into the metal case (12), until the bob (18) buts against the periphery of the metal case (12). In this way, the cell phone can be extended and retracted as needed.

Having generally described the exterior components and operation of a retractable cell phone clip (10) embodying the invention, an internal mechanism for achieving the automatic retraction of the metal cord (14) will now be presented. It is noted that this internal mechanism is only an example of one preferred embodiment and is not intended that the invention be limited to just this embodiment. Rather, any mechanism that causes the case (12) reel to spin when the metal cord (14) is extended or retracted could be substituted. The important aspect is that the case (12) reel rotates, not particularly how it is made to rotate.

Referring to FIGS. 1A, 1C and 7A, the case (12) includes a back piece and a cover, each of which can be formed from molded plastic, metal or any other appropriate casing material. The back piece of the cover has a centrally-located slotted post that protrudes up perpendicularly from its inner wall. A reel (26) is disposed within the interior space of the case (12). The reel (26) has a disc shaped backwall with a central hole (28), which has a diameter slightly exceeding that of the slotted post. A ring-shaped projection extends out from the interiorfacing side of the backwall slightly inward of its peripheral edge. An annular wall (30) preferrably extends out the same distance as the backwall. The foregoing structure of the reel (26) defines a groove having sidewalls formed by the peripheral portion of the backwall and the annular wall (30) and a floor formed by the ring-shaped projection. In addition, the ring-shaped projection and the inner portion of the backwall define a central cavity (32) of the reel. The reel (26) is positioned onto the slotted post such that the slotted post extends through the central hole (28) of the spool backwall and into its central cavity (32). Preferrably, the slotted post extends out to a point approximately flush with the mouth of the central cavity (32). The reel (26) is free to rotate about the slotted post within the interior space of the case (12) owing to the diameter of the slotted post being slightly smaller than that of the central hole (28) of the spool backwall. A wind-up spring (34) is disposed within the central cavity (32) of the reel. The spring (34) can be made of any resilient material, such as spring steel. The inner end of the spring (34) is secured in place by threading it through and around the slot in the slotted post. The spring (34) forms a convoluted winding within the central cavity (32), with the outer end of the spring (34) extending out of the cavity (32) through a gap in the ring-shaped projection. The outer end of the spring (34) is threaded through a slot formed through the ring-shaped projection from the groove side of the projection back into the central cavity (32) so as to secure the outer end of the spring (34) to the reel (26). Thus, the inner end of the spring (34) is secured to the back piece via the slotted post, and the outer end of the spring (34) is secured to the reel (26). The ringshaped projection also has a through-hole through which one end of the metal cord (14) is threaded from the groove side of the projection. This end of the metal cord (14) is secured to the reel (26) within the central cavity (32).

In its retracted mode, the metal cord (14) is completely wound around the reel (26) and contained within its groove, with the exception of a short length at its free end that extends through the port in the case (12) and is attached to the aforementioned bob (18). As stated previously, the metal cord (14) is under tension and only the bob (18) keeps it from fully retracting into the case (12). This tension on the metal cord (14) is created by the spring (34). Essentially, a wind-up spring wants to uncoil. Because one end of the spring (34) is anchored to the case (12) via the slotted post of the back piece and the other end is attached to the reel (26) and coiled within the central cavity (32) of the reel, the result is a rotational force on the reel (26) about the slotted post. Depending on how the spring (34) is attached between the slotted post and the reel (26), the direction of the rotational force may be either clockwise or counterclockwise. Either direction is acceptable, as long as the metal cord (14) is wrapped around the reel (26) in the direction opposite of the rotational force on the reel (26). In this way, the rotational force tends to want to wrap the metal cord (14) further onto the reel (26). In the aforementioned fully retracted mode, the spring (34) is wound tight enough to ensure the weight of any attached cell phone will not be sufficient to overcome the resulting pre-tension. Thus, the cell phone is held in place on the retractable cell phone clip/hook (10). As the metal cord (14) is pulled out, as when the cell phone is in use, the reel (26) rotates in relation to the case (12) a direction that causes the spring (34) to wind even more tightly. Accordingly, when the user releases the extended cell phone, the spring (34) tension causes the reel (26) to rotate in the opposite direction so as to take up the cord (14) into the groove of the reel (26) until the bob (18) butts against the peripheral edge of the case (12). It is noted that the spring (34) is designed via conventional methods so that when the cord (14) is fully extended from the case (12) of the retractable cell phone clip/hook (10), the tension is not so great that a user cannot easily hold the cell phone in place without it being pulled free from the user's hand.

While the invention has been described in detail by reference to the preferred embodiment described above, it is understood that variations and modifications thereof may be made without departing from the true spirit and scope of the invention. For example, while the present invention has been described in the context of a retractable cell phone clip/hook, keys are often carried by persons using a retractable key ring like the key ring connector securing unit. In such a device, the keys are held close to the body of the key chain, which is typically attached to the clothing of the user. The keys are attached to a key ring, which is in turn attached to an extendable and retractable cord, similar to the one used in connection with the present invention and the key ring connector securing unit.

Wherefore, what is claimed is:

1) A retractable holding apparatus, comprising:
a case securing unit which is capable of attachment to an article securing unit being connected to an extendable and automatically retracting cord housed inside said case.

2) The apparatus of claim 1, wherein the article which is held by the holding apparatus comprises a key ring connector securing unit with an attached universal cell phone securing string.

3) The apparatus of claim 1, further comprising a releasable attachment device connected to a topside of said case which is capable of releasably attaching the retractable holding apparatus to the clothing, purse or backpack, etc. of a user.

4) The apparatus of claim 1 wherein the case, when viewed from its front or backside, comprises a shape approximating one of a circle.

5) A retractable cell phone clip, comprising:
a case having a cord which is normally retracted within the case with the exception of a free end thereof which extends outside the case through a hole in the periphery of the case, said cord being manually extendable from the case by a user and under tension from within the case such that when extended from the case and released, or when the free end of the cord guided back to the case by the user, said tension on the cord causes it to retract back into the case; and
a key ring connector securing unit which is capable of attachment to a universal cell phone securing string with a cell phone and which is connected to the free end of said cord, and wherein; said cell phone is extended from or retracted back into the case.

6) The retractable cell phone clip of claim 5, wherein the universal cell phone string securing unit comprises:
a bob which is connected to said free end of the cord, said bob being larger than said hole in the periphery of the case at its point of connection to the free end of the cord so as to prevent the free end of the cord from retracting into the case; and
a key ring connector securing unit which is connected to the bob; and
a universal cell phone string securing unit which is connected to the key ring connector securing unit.

7) The retractable cell phone clip of claim 6, where the tension applied to the cord in a fully retracted mode is sufficient to hold the bob against the periphery of the case when a cell phone is attached to the retractable cell phone clip universal cell phone string securing unit.

8) The retractable cell phone clip of claim 7, further comprising a releasable attachment clip/hook connected to the topside of said case which is capable of releasably attaching the case to the clothing, a purse or backpack, etc. of a user such that a cell phone attached to the retractable cell phone clip universal cell phone string securing unit hangs down from the retractable cell phone clip when the cord is in its fully retracted mode.

9) The retractable cell phone clip of claim 5, wherein the length of the cord is such that the user can extend the cord a sufficient distance to present a cell phone attached to the universal cell phone string securing unit for inspection.
